(19) United States
(12) Patent Application Publication
(10) Pub. No.: US 2014/0184861 A1
(43) Pub. Date: Jul. 3, 2014

(54) ACCURATE PLENOPTIC RENDERING WITH DEFOCUS BLUR

(71) Applicants: Todor Georgiev, Sunnyvale, CA (US); Elka Georgieva, Sunnyvale, CA (US)

(72) Inventors: Todor Georgiev, Sunnyvale, CA (US); Elka Georgieva, Sunnyvale, CA (US)

(21) Appl. No.: 13/731,020

(22) Filed: Dec. 30, 2012

(51) Int. Cl. H04N 9/07

(52) U.S. Cl. CPC H04N 9/07
USPC 348/262

(57) ABSTRACT

This invention claims a general plenoptic camera in which microlenses are replaced with optical imaging elements that in different embodiments may be compound lenses, diffractive optical elements, plenoptic cameras, or others. It also claims methods of rendering images from plenoptic data. In one embodiment a robust algorithm is shown for plenoptic rendering that. In another embodiment, a robust plenoptic rendering algorithm is shown that also produces optically accurate defocus blur without rendering artifacts. The embodiments produce good results with randomly placed microlenses, missing microlenses and in cases when there are defective parts of the image.

The present application is a continuation of and claims priority to Provisional Application Ser. Nos. 61/584,220 filed Jan. 7, 2012, 61/583,183 filed Jan. 5, 2012, and 61/584,264 filed Jan. 8, 2012, the contents of which are incorporated by reference.

### BACKGROUND OF THE INVENTION

The idea of integral or plenoptic camera has been proposed in 1908 by G. Lippmann, and the recipe used today for building such cameras has been given by Ives in 1930. Ives' camera consists of a main camera lens imagining the outside objects onto the plane of an array of microlenses. The microlens array is positioned approximately at the focal plane of a large format camera, i.e. at the main lens image plane. Sensor/film is placed at the focal plane of the microlenses.

One prior art embodiment 100 of the plenoptic camera is shown in FIG. 1. The microlenses 110 are placed at a distance a from the main lens image plane 120. The sensor 130 is positioned at a distance b from the microlens plane, b>f so that the lens equation 1/a+1/b=1/f holds true. The focal length of all microlenses is f. The camera can be viewed as an array of Keplerian telescopes with a common objective lens.

In another version of this embodiment, the distance a is negative, i.e. the main lens image plane is behind the sensor plane. For this camera b<f. This version is analogous to the Galilean telescope.

The array of microlenses in a plenoptic camera may be replaced with an array of more general optical imaging elements that will be called elemental lenses. The plenoptic camera with elemental lenses is a relay system: An array of elemental lenses maps pieces of the main camera lens image onto the sensor, forming an array of elemental images.

After image capture, rendering is done by software that combines the elemental images into a final rendered image. The rendered image can be refocused after the fact, depth of field can be changed, and 3D views can be generated.

One main problem of prior art algorithms has been the existence of artifacts in the rendered image. Due to the sparse positioning and periodicity of microlenses, prior art algorithms usually produce unnaturally looking defocus blur in out of focus areas. Such artifacts are unacceptable for professional imaging and must be avoided. Another problem of prior art is the lack of robustness of the rendering process. Defective microlenses, or blemishes on the sensor like individual dead pixels create visible blemishes in prior art rendering. Considering the redundancy of plenoptic images, it's clear that it must be possible to substitute missing data in one elemental image with data from another elemental image and compensate for such defects.

### SUMMARY OF THE INVENTION

In one aspect, a computer-implemented image processing method includes receiving one elemental image created by one elemental lens; receiving a center and size of said elemental image; receiving depth of rendering a from the elemental lens center of projection to a final image; receiving a distance b from the elemental lens center of projection to a sensor; receiving coordinates of a point P in the final image; and computing a color of the point P in a final rendered image.

In another aspect, a camera includes main camera lens to create an image; plurality of optical imaging elements receiving rays from said image; plurality of sensors on which elemental images are formed by said optical imaging elements; and a data storage device to record the elemental images digitally.

Advantages of the system may include one or more of the following. The system provides a generalized version of the plenoptic camera, in a plurality of related embodiments, that achieve better quality imaging. Also, the system provides a way to render images from Plenoptic camera data, in an accurate and robust way: Given the array of elemental images, embodiments of the invention compute the original image produced by the main lens as it would have appeared at an image plane placed at a virtual distance a in front of the elemental lenses.

The new process renders optical quality defocus blur in out of focus areas, without artifacts. Also, it robustly handles cases of defective or displaced elemental lenses. Even an array of randomly placed elemental lenses or array composed of two or more separate arrays, next to each other and slightly displaced, produces rendering results without artifacts.

### BRIEF DESCRIPTION OF THE DRAWINGS

FIG. 1 shows a prior art plenoptic camera.

FIG. 2 shows the basic geometry of elemental lens imaging. The path of rays from a virtual object plane to sensor plane is shown.

FIG. 3 shows the geometry used in one example of computation of the sampling locations for determining the color of a point P in the object plane in front of the elemental lenses.

FIG. 4 shows one example of computing the sampling locations for the color of a point P from 4 elemental images.

FIG. 5 shows the geometry used when computing color of a point P in the object plane from a given elemental image based on the second embodiment.

FIG. 6 shows the flowchart describing the process of computing the color of point P from one elemental image according to the second embodiment.

FIG. 7 shows a display system that may benefit from the invention.

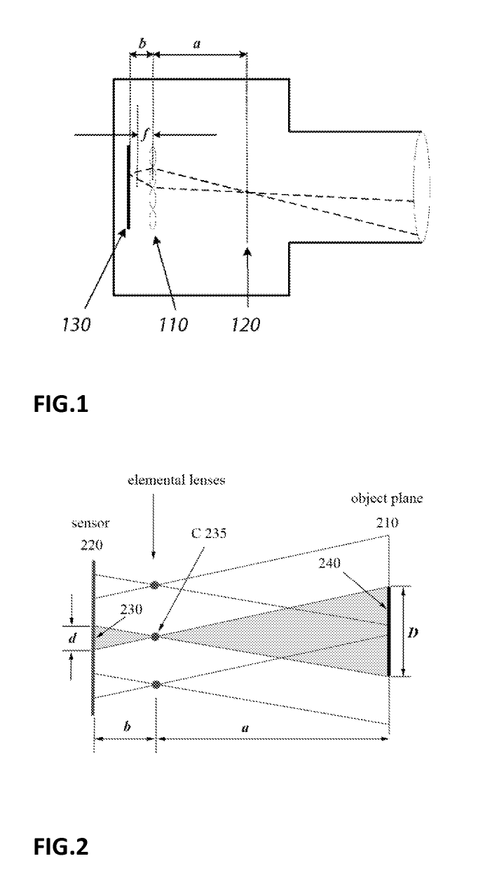

### DETAILED DESCRIPTION OF THE INVENTION

In different embodiments of this invention, the array of microlenses in a plenoptic camera are replaced with different arrays of more general optical imaging elements. Each of these optical imaging elements serves the role of remapping part of the main lens image to the sensor. These optical imaging elements could be microlenses, or optimized multi-element lenses, or diffractive optical elements, or pinholes, or others. The optical imaging elements may even be full plenoptic cameras. These more general optical imaging elements will be called elemental lenses.

The generalized plenoptic camera is a relay system: An array of elemental lenses maps pieces of the main camera lens image onto the sensor, forming an array of elemental images. Any elemental lens can be characterized by its focal length and two principal planes, considering the virtual path of light rays. Light rays virtually travel to the first principal plane of the elemental lens, then are refracted by the elemental lens of focal length f, then travel from the second principal plane to the sensor. When the elemental lens is not just a thin lens the meaning of a and b needs to be redefined: The distance from the sensor to the second principal plane is b. The distance from the second principal plane to where the object would appear to be as seen from two or more elemental lenses is a. The distance a is the depth to the object as measured based on the elemental images. It can be computed based on computer vision algorithms. Due to refraction in the elemental lens this distance may be different from the real distance to the main lens image plane. (That's actually the effect of optical devices, such as the telescope, which make distances appear different.) In a similar way, when there is no main lens, and the plenoptic camera is simply an array camera, a is the computed distance to the object and it may be different from the real distance.

In all figures starting with FIG. 2, the elemental lens will be represented as a dot placed at the center of projection of the elemental lens as seen from the sensor. This is exactly the physical center of projection when the elemental lens is a pinhole. This is the physical center of the lens when the elemental lens is a thin lens. It is the intersection of the optical axis with the second principal plane when the elemental lens is a multi-element lens.

FIG. 2 shows the optical paths between where the object plane 210 appears to be as determined from elemental images and the sensor plane 220. The object plane may be the virtual main lens image plane as seen from the elemental lenses. In all cases that's the plane where focusing and computational image synthesis will be computed. The size of an elemental image 230 is d and the corresponding area 240 in the object plane has size D. Considering similar triangles, D/d=a/b. Based on the center of projection C 235 of the elemental lens, the same a/b relationship holds for the coordinates of any two corresponding points in the object plane and the elemental image plane.

### First Embodiment of a Process for Plenoptic Rendering

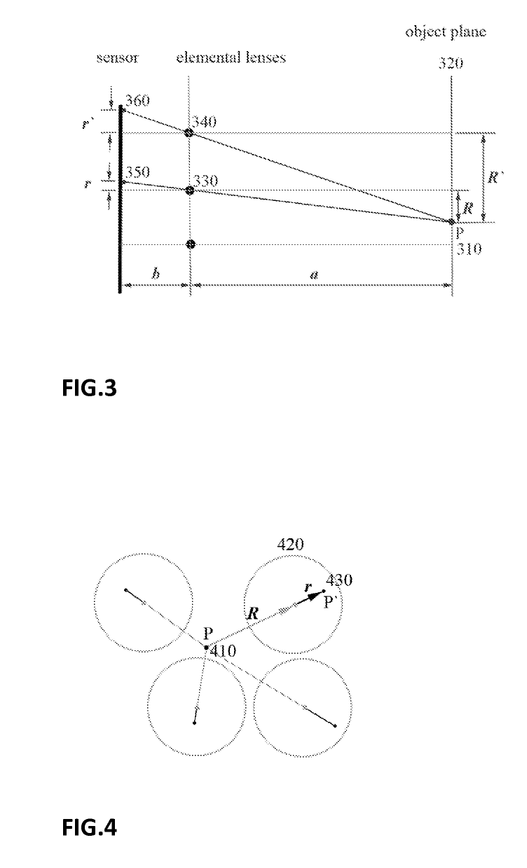

Considering FIG. 3, an algorithm is described for finding the images of an arbitrary point P created on the sensor by different elemental lenses. A point P 310 in object space 320 appears at a distance R from the optical axis of a given elemental lens 330, and at a distance R′ from the optical axis of another elemental lens 340. The images 350 and 360 of P produced by the two elemental lenses on the sensor are at distances r and r′ from the optical axes of the corresponding elemental lenses. Based on similar triangles R/r=a/b and also R′/r′=a/b. This relationship holds for any image of P generated by any elemental lens.

The goal of plenoptic rendering is to synthesize a focused image in object space, the plane 320, at distance a+b from the sensor plane. In relation to FIG. 3, a first embodiment of a process for plenoptic rendering is described.

For any given elemental lens 330 and point P 310, the quantities R, a and b are predefined. Based on that, the quantity r is calculated. Then the color of the image at point P in the main lens image plane is obtained by sampling from the point in elemental image 350 that belongs to elemental lens 330, and for which r=R b/a. This expression is general. It is true for any elemental image given a distance R from the point P to the center of that elemental image. As seen in FIG. 3, a plurality of elemental lenses may map point P to their elemental images. Because of that, the color of P is computed multiple times. This leads to the robustness of the method. The final color may be computed as the average or the median of all colors, or computed as an average in which some elemental images may be excluded based on detected blemishes at an earlier calibration stage.

### Calibration for the Centers of Elemental Images

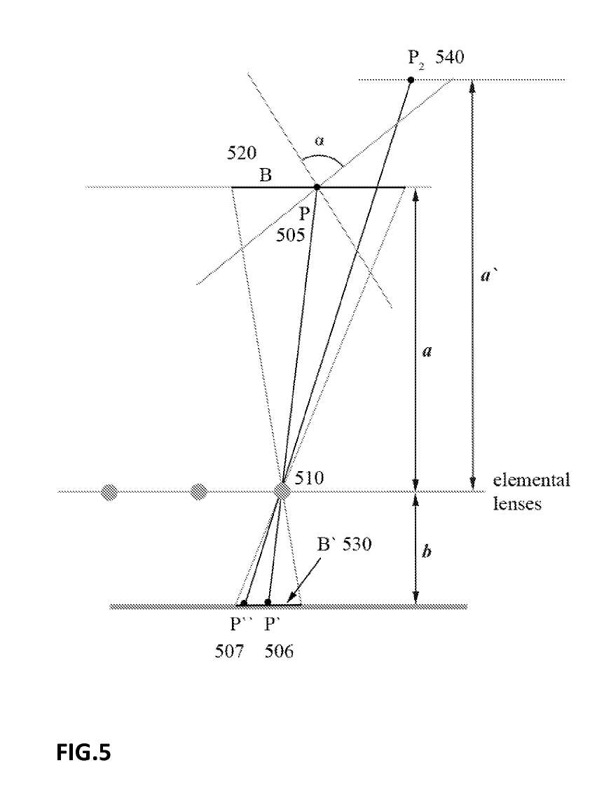

It should be clear that r and R are 2D vectors because the above equations hold both for the x and they components. FIG. 4 shows an example of computing one sampling location P′ for a point P 410. The sampling location 430 is in the elemental image 420. Four arbitrarily placed elemental images are represented as circles in this case. In the general case of randomly placed elemental lenses, the centers need to be known. Centers of elemental images are determined based on a calibration step done in advance: By imaging a white point at infinity, the elemental lenses produce white dots at the centers of all elemental images. The coordinates of those white dots are extracted from the images and used as calibration data.

This calibration procedure makes the embodiments of a computational plenoptic rendering in this invention robust to the positioning of the elemental lenses. The rendering algorithms can handle arbitrarily placed elemental lenses. Such capability is new in plenoptic rendering.

### Constraining Sampling Locations

Not all pixels are used in rendering the final color at a given point. For example, r might be greater than the radius of the elemental image circle. In a variation of this consideration, r may come out of the rectangle or out of the shape of the elemental image. The algorithm checks to find out if that is the case, and if so it does not attempt to sample from that particular pixel.

Elemental lenses that are too far from P are naturally excluded by that condition. Thus, the exact elemental images from which the color for point P is sampled is calculated automatically and typically the number of such images is of the order of 20 to 100 or more. One useful condition is that no sampling is performed more than 10 elemental lenses away from P. In other words, the loop that goes through elemental images to sample from is set up to cover only a predefined number of lenses that may be from −10 to 10 in x and from −10 to 10 in y direction. Ina a variation of this embodiment, sampling may be constrained to be performed only within certain radius from P, which radius may be described as 10 lenses away from P.

### Conditions Preventing Sampling

The above constraining of sampling locations provides only one of the conditions for sampling. Another condition may exclude pixels that are predetermined to be “hot pixels” or defective in other ways. Determining hot pixels, dead pixels and defective pixels is prior art for this invention.

Other conditions for sampling, based on calibration, exclude defective elemental lenses or areas, etc. The defective elemental lenses are detected at calibration time and the pixels in their elemental images are also marked in an exclusion mask, so they are not used. For example if at a calibration stage with diffuse light illumination certain elemental image is significantly darker than the other elemental images, this elemental lens may be considered defective and all pixels in that elemental image may be excluded. Such pixels are marked in an exclusion mask. In a more sophisticated algorithm a defective lens may have certain weight or probability of being unusable. That weight may be measured by the degree of difference of the calibration image from that lens compared to the average calibration image. For example, this degree may be computed as the difference of each pixel value from the average divided by the average. Similar weights may be computed for hot pixels or dead pixels. In the end this information may be recorded as a floating point number or as appropriate integer in the exclusion mask.

The final rendering needs to handle all of the above cases and may also handle other cases in which sampling is nor desired. This is done by creating an exclusion mask at an earlier calibration stage. The exclusion mask prevents using certain pixels for the computation of the final pixel value.

Final Rendering with Accumulation Buffer

Based on the above constraints and exclusion mask, the color of any point P in object space may be computed as long as one or more pixel values of point P have been sampled from the data recorded in one or more elemental images. The algorithm uses an accumulation buffer to add up all valid samples available for a given final pixel P. A counter computes the number of samples. In a variation of this method, all such values may be individually recorded. In the end the output pixel value is computed as a combination of all pixels, which may be the average or the median.

In yet another variation of the accumulation buffer approach an exclusion mask with weights may be used. Each sampled pixel value is assigned a weight or probability of being usable. Such weights may be available based on calibration. Each sampled pixel value is multiplied by its weight and all are added. In the end the total sum is divided by the sum of weights. Even if this algorithm is described in relation to the first embodiment, it also applies to the second embodiment and is very general.

Since point P has been chosen arbitrarily, the algorithm covers all points in object space, i.e. all points at a distance a from the first principal plane of the elemental lenses.

As mentioned above, with this method very robust estimate of the pixel value at P can be produced, even in the case of noisy or severely damaged images. For example, this happens in the cases where several lenses are missing, or the sensor has dead pixels or whole lines of pixels are missing. One very important case is a sensor of high resolution assembled from two or more sensors placed next to each other. Removing the gap between the sensors has been a significant problem in prior art.

Notice also that no periodicity is required for the elemental images. Images may be rendered from randomly positioned elemental lenses. The only requirement is that the centers of the elemental images are known.

The above process may also be used for refocusing: Given any new distance a′, the process computes a′/b and applies the same method to synthesize a new image focused on the new image plane at a distance a′ from the lens array first principal plane. Unfortunately, when difference between real and rendered depth of out of focus images is too big, the defocus blur begins to show unwanted artifacts. This problem is common for all plenoptic rendering algorithms, and it will be solved in the second embodiment.

### Second Embodiment of a Process for Plenoptic Rendering

The first embodiment assumes constant depth a at which the main lens image is focused in front of the elemental lenses. In reality, a point P from the main lens image focal plane may have depth a′ that is different from a. As discussed above, rendering such point P as if it was at depth a may introduce defocus blur that does not look smooth and realistic. The blur has artifacts of rendering that are typical for prior art algorithms.

Referring to FIG. 5, the second embodiment claims an algorithm for rendering each point of the image plane by using much larger set of sensor data compared to the previous algorithm. The method and criteria for selecting and combining this data into one single pixel value in order to obtain natural looking blur are described below.

The algorithm uses depth computed for each pixel in the elemental images in advance. This computation may be performed using prior art stereo algorithms which find stereo depth from multiple views as provided by plurality of elemental lenses. In this case the result is that each pixel in the elemental images contains the values Red, Green, Blue and Depth (RGBD).

Alternatively, each elemental lens may comprise the optics of a separate plenoptic camera. In this case it may individually serve the purpose of capturing depth information. Such depth from plenoptic camera may be computed based on prior art algorithms. Again the result is that each pixel in the elemental images contains the values Red, Green, Blue and Depth (RGBD).

The second embodiment provides a more sophisticated sampling algorithm, which does not simply read one pixel from each elemental image, but combines a large number of pixels in certain area B′ in the elemental image in order to produce one RGB value for output.

The algorithm is based on the following assumptions:
1. The maximum defocus blur radius in object space is B. The value of B is selected by the user.
2. The elemental lenses capture only those rays coming from point P that are inside a cone with vertex at point P and with angle α. This angle will be referred as the acceptance angle. The acceptance angle α is a user supplied parameter that influences the quality of rendering. The point P is considered inside the cone, and the axis of the cone is along the line that connects P with the center of projection of the elemental lens under consideration. The first embodiment is equivalent to α=0.
3. The depth a′ of each pixel in each elemental image is known.

Referring to FIG. 5 the algorithm for rendering applied to a single elemental lens is as follows:
1. Map the point P 505 to a pixel location P′ 506 in the elemental image created by the elemental lens 510. This mapping is defined by the straight line from point P through the center of projection of elemental lens 510, and is computed based on the a/b formula of the first embodiment. This step is no different from the corresponding step in the first embodiment.
2. Map the blur range B 520 to the elemental image where it covers area with radius B′ 530. As in step 1, this mapping is done by projecting through 510 or equivalently by using the a/b formula of the first embodiment. Alternatively the whole elemental image may be used, totally ignoring B at the cost of worse performance. This will be discussed later.
3. Set up an accumulation buffer for the output pixel value p and a counter indicating how many values are added to the buffer. Both counter and pixel value are initialized to 0.
4. For each pixel P″ in the region with radius B′ 530:
   Compute the point P₂ 540 in object space P₂=(x, a′−a) that generates this pixel. Here x measures the 2D horizontal component of the 3D vector from point P to point P₂, and a′ is the depth to point P₂
   Test to find out if P₂ is inside of the cone at point P with angle α,
      if yes, add it to an accumulation buffer and update the counter;
      if no, discard it. Rays from outside the cone cannot influence the final image.
5. Find the average of all pixel values added to the buffer. There is at least one term in the sum, the pixel value in the initial pixel location P′ 506.

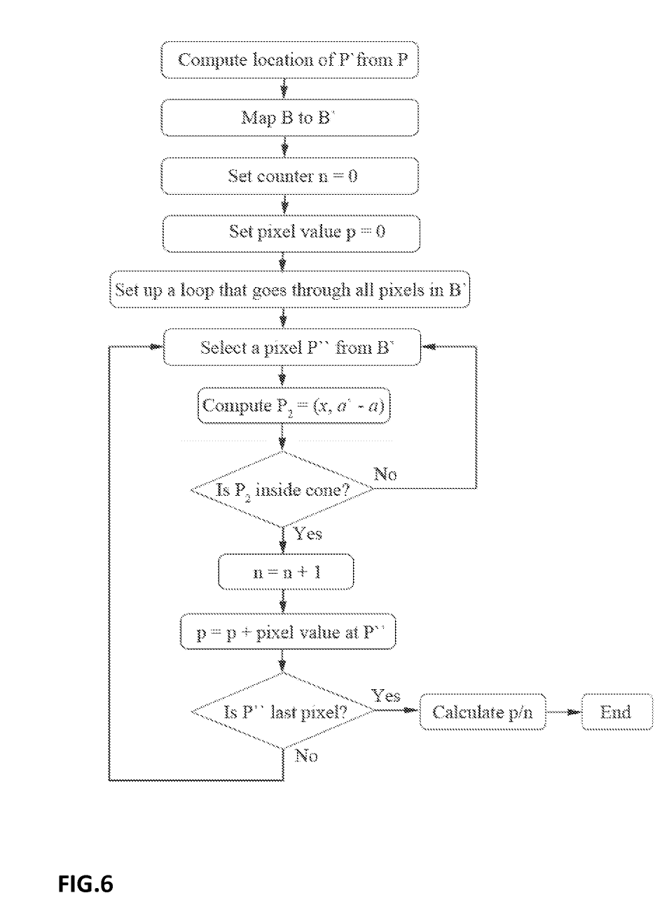

A flowchart of the process of embodiment 2 is shown in FIG. 6.

Note that B is a user defined parameter and it provides only a trade-off between speed and accuracy. If we make B=∞, i.e. if we use absolutely all pixels in the elemental image, many of them would produce points P₂ that are outside the cone and not used at all. So B is mostly helping avoid tests that are not needed.

Part of the algorithm is a test that determines if a point P₂ is inside the cone with vertex at point P and angle α. The angle of the ray through P and P₂ is approximately x/(a′−a), where x may be approximately computed from the distance between P′ and P″ based on the a′/b formula. The result is (P″−P′)a′/b(a′−a). The test compares this angle with half angle α. More precise ways of finding the angles are also possible, but since α is provided by the user and approximate, such precision may have little effect on the quality of the final result.

In a variation of the method that determines if P₂ is inside the cone, a more sophisticated method may determine with what weight the point P₂ is inside the cone. Such method may be based on the degree to which the angle of the ray through P and P₂ is close to half the acceptance angle of the cone. Such weight may be used in a summation with weights fashion in the algorithm for rendering—instead of summation of all applicable pixel values in the accumulation buffer (step 4 of the algorithm for rendering of the second embodiment). If so, step 5 of the algorithm would divide by the sum of all weights instead of simply finding the average. This is a generalization of the rendering algorithm of the second embodiment. It can also be considered as a generalization of the exclusion mask with weights method: If a sampled pixel already has weight, it is multiplied by the above weight of being inside the acceptance cone, and the product used as the weight in the generalized algorithm. The result is better quality in terms of representing edges and smoothness of blur.

The second embodiment provides a more robust sampling for the color of point P based on one single elemental lens and its elemental image with depth. It more correctly handles the defocus blur of sampling elemental images. As in the first embodiment, the final image is a combination of the plurality of pixel values that have been sampled from a potentially large number of elemental images. Each act of sampling is performed using the above algorithm.

As in the first embodiment, the second embodiment combines the pixel values that come as a result of sampling using the same methods. The same calibration data is used, same constraints for sampling locations, the same conditions preventing sampling and exclusion mask are used. Also the same final rendering methods with accumulation buffer may be utilized based on the exclusion mask and the exclusion mask with weights. The main difference is the more sophisticated sampling from each individual elemental lens.

The second embodiment has all the benefits of the first embodiment, for example it handles arbitrary placement of the elemental lenses, missing/defective elemental images lenses, etc. Additionally, the second embodiment produces smooth optically correct defocus blur.

Both embodiments of the invention work with an array of cameras (light field array) equally well as with plenoptic cameras. Having a single main camera lens in front of the array of cameras is not a significant factor.

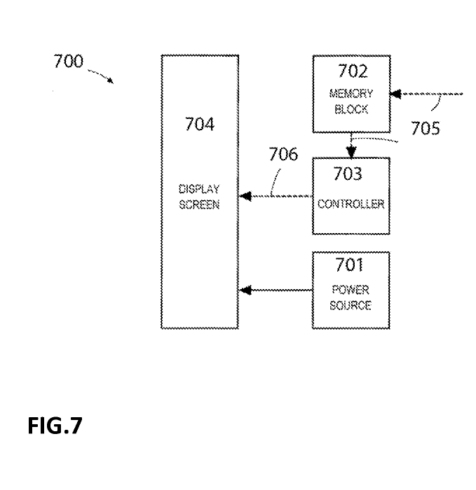

FIG. 7 shows a block diagram of a display system 700 that may benefit from embodiments of the invention. Display system 700 may be used to display a series of images, also referred to as frames, to produce a video sequence, or alternatively, a single static image. Display system 700 includes a power source 701, a memory block 702, a controller 703, and a display screen 704. Power source 701 may be a

conventional electrical outlet, such as a 110 VAC or 220 VAC electrical outlet, a hardwired electrical connection, or other electrical connection that provides the requisite voltage and amperage for the proper operation of display system 700. Memory block 702 may include DRAM, flash memory, or other memory devices for retaining image data 105 that is used to construct one or more images to be displayed by display system 700. Controller 703 may include one or more appropriate processors for
converting image data 705 in memory block 702 to output signal 706, including general purpose processors such as micro-processors, digital signal processors (DSP), and special purpose processors, such as an application specific integrated circuits (ASICs). Display screen 704 may be an organic light emitting diode (OLEO) based display screen, or other electronic display screen that generates a combination of different colors of light, e.g., red, green, and blue, at each pixel to produce the desired brightness and hue for that pixel. For example, a pixel of display screen 704 may include a red, a green, and a blue (RGB) sub-pixel, which are used to generate the requisite red, green, and blue light that, in combination, produces the desired hue and brightness for the pixel. In an OLEO-based display screen,
such subpixels may be comprised of polymeric conducting and emissive layers positioned between an anode and a cathode. Display screen 104 may be based on other technologies as well, such as a light-emitting diode (LED) array.

What is claimed is:

1. A computer-implemented image processing method, comprising:
receiving one elemental image created by one elemental lens;
receiving a center and size of said elemental image;
receiving depth of rendering a from the elemental lens center of projection to a final image;
receiving a distance b from the elemental lens center of projection to a sensor;
receiving coordinates of a point P in the final image; and
computing a color of the point P in a final rendered image.

2. The method of claim 1, wherein the elemental image is sampled by sampling the pixel value located at point r=R*b/a if that elemental image is no more than 10 elemental lenses away from the point P and if point r is inside the elemental image, where R is a vector from point P to the center of elemental image, and r is a vector from the center of the elemental image to the sampling point.

3. The method of claim 2, further comprising:
receiving a plurality of elemental images
receiving the center and size of each elemental image
computing the color of point P as average of the colors that have been sampled individually from each one of the plurality of elemental images.

4. The method of claim 3, further comprising receiving an exclusion mask or exclusion mask with weights defining exclusion or permission for sampling from each pixel in the plurality of elemental images, and using the exclusion mask or exclusion mask with weights with an accumulation buffer to compute the pixel value of P.

5. The method of claim 4, further comprising:
receiving a depth value for each pixel in each elemental image;
receiving the value B of a maximum blur radius;
receiving the value α of an acceptance angle of the cone associated with computational sampling from elemental images; and
computing the color of the point P in the final rendered image.

6. The method of claim 5, further comprising
a. receiving a pointer to one selected elemental image;
mapping point P to point P′ in the selected elemental image using projection through the center of the corresponding elemental lens;
mapping the area B around point P to area B′ in the elemental image;
setting up a computation loop that goes through all pixels in the area B′ inside which loop the decision is made as to whether or not each individual pixel in the elemental image should be used for the computation of the color of P, or with what weight the pixel should be used;
computing final pixel value for P based on using the output of said computation loop.

7. The method of claim 6, wherein the computation loop comprises
mapping each pixel location P″ inside B′ to a point P₂ through the center of projection of the elemental lens using the depth recorded in pixel P″;
determining if P₂ is inside the acceptance cone with angle α at point P, or the weight of being inside the cone;
and wherein computing the final pixel value comprises
computing the sum of the values, or the weighted sum, of all pixels from B′ that can be used according to the said computation loop;
computing the number of pixels or the sum of the weights in the said computation loop;
computing the final pixel value of P as the sum of all pixels used divided by the number of pixels, or the weighted average divided by the sum of weights.

8. The method of claim 7, further comprising
selecting individually every elemental image in a given range of elemental lenses around point P and applying the method of claim 7 to it to produce a pixel value for P;
Computing the average of all said pixel values of P.

9. The method of claim 7, further comprising
selecting individually every elemental image in a given range of elemental lenses around point P and applying the method of claim 7 to it to produce a pixel value for P;
Computing the weighted average of all said pixel values of P, with weights computed according to usability of defective lenses determined at calibration time.

10. The method of claim 7, further comprising
selecting individually every elemental image in a given range of elemental lenses around point P and applying the method of claim 7 wherein computing the final pixel value comprises applying the following computation to every elemental image and accumulating the following results of all elemental images
computing the sum of the values, or the weighted sum, of all pixels from B′ that can be used according to the said computation loop;
computing the number of pixels or the sum of the weights in the said computation loop;
and in the end computing the final pixel value of P as the sum of all pixels used divided by the number of pixels, or the weighted average divided by the sum of weights.

11. The method of claim 1, comprising using an array of elemental lenses to map pieces of a main camera lens image onto one or more sensors, forming an array of elemental images, and characterizing an elemental lens by its focal length and two principal planes, considering a virtual path of light rays.

12. A camera comprising:
main camera lens to create an image;
plurality of optical imaging elements receiving rays from said image;
plurality of sensors on which elemental images are formed by said optical imaging elements; and
a data storage device to record the elemental images digitally.

13. The camera of claim 12, wherein the optical imaging elements comprise diffractive optical elements (DOE).

14. The camera of claim 12 wherein the optical imaging elements comprise optimized compound lenses.

15. The camera of claim 12 wherein each optical imaging element comprises the optics of a plenoptic camera.

16. The camera of claim 12 wherein the optical imaging elements are heterogeneous mixture of different types of elemental lenses.
